(19) United States
(12) Patent Application Publication
(10) Pub. No.: US 2026/0042171 A1
(43) Pub. Date: Feb. 12, 2026

(54) SUBSTRATE PROCESSING APPARATUS AND SUBSTRATE PROCESSING METHOD

(71) Applicant: Tokyo Electron Limited, Tokyo (JP)

(72) Inventor: Yohei YAMASHITA, Kikuchi-gun, Kumamoto (JP)

(73) Assignee: Tokyo Electron Limited, Tokyo (JP)

(21) Appl. No.: 19/101,900

(22) PCT Filed: Apr. 25, 2023
(86) PCT No.: PCT/JP2023/016358

§ 371 Date: Feb. 7, 2025

(30) Foreign Application Priority Data
Aug. 9, 2022 (JP) 2022-127420

(51) Int. Cl. B23K 26/53; B23K 26/0622; B23K 26/08; B23K 26/082; B23K 26/18; B23K 101/40

(52) U.S. Cl. CPC B23K 26/53; B23K 26/0622; B23K 26/082; B23K 26/0823; B23K 26/083; B23K 26/0869; B23K 26/18; B23K 2101/40

(57) ABSTRACT

A substrate processing apparatus for processing a combined substrate in which a first substrate, an interface layer including at least a laser absorption layer, and a second substrate are stacked is provided. An outer peripheral region including a non-bonding region of the first substrate and the second substrate, and an inner peripheral region in a bonding region are set in the combined substrate. A controller executes: a control of causing separation at an interface between the first substrate and the laser absorption layer or at an interface between the interface layer and the laser absorption layer by radiating laser light to the combined substrate while rotating the combined substrate and moving the laser light in the radial direction; and a control of radiating the laser light while moving the laser light from an inner side toward an outer side in the radial direction.

### TECHNICAL FIELD

The various aspects and embodiments described herein pertain generally to a substrate processing apparatus and a substrate processing method.

### BACKGROUND

Patent document 1 discloses a method in which a semiconductor element of a semiconductor substrate, which has a separation oxide film and the semiconductor element formed on a front surface thereof, is transcribed to a destination substate. The method described in Patent Document 1 includes a process of radiating light from a rear surface of the semiconductor substrate to locally heat the separation oxide film, and a process of causing separation in the separation oxide film and/or at an interface between the separation oxide film and the semiconductor substrate to transcribe the semiconductor element to the destination substrate.

### PRIOR ART DOCUMENT

Patent Document 1: Japanese Patent-Laid open Publication No. 2007-220749

### DISCLOSURE OF THE INVENTION

### Problems to be Solved by the Invention

Exemplary embodiments provide a technique capable of appropriately carrying out separation of a first substrate and a laser absorption layer in a combined substrate in which the laser absorption layer is formed at an interface between the first substrate and a second substrate.

### Means for Solving the Problems

In an exemplary embodiment, there is provided a substrate processing apparatus configured to process a combined substrate in which a first substrate, an interface layer including at least a laser absorption layer, and a second substrate are stacked. The substrate processing apparatus includes a substrate holder configured to hold the combined substrate; a laser radiator configured to radiate laser light to the combined substrate held by the substrate holder; a moving mechanism configured to horizontally move the substrate holder and the laser radiator relative to each other; a rotating mechanism configured to rotate the substrate holder; and a controller. An outer peripheral region including a non-bonding region of the first substrate and the second substrate, and an inner peripheral region disposed inside the outer peripheral region in a radial direction in a bonding region of the first substrate and the second substrate are set in the combined substrate. The controller executes: a control of causing separation at an interface between the first substrate and the laser absorption layer or at an interface between the interface layer and the the laser absorption layer by radiating the laser light to the combined substrate while rotating the combined substrate and moving the laser light in the radial direction; and a control of radiating, at least in the outer peripheral region, the laser light while moving the laser light from an inner side toward an outer side in the radial direction.

### Effect of the Invention

According to the exemplary embodiment, it is possible to appropriately carry out the separation of the first substrate and the laser absorption layer in the combined substrate in which the laser absorption layer is formed at the interface between the first substrate and the second substrate.

### BRIEF DESCRIPTION OF THE DRAWINGS

FIG. 1 is a side view illustrating a configuration example of a combined wafer according to an exemplary embodiment.

FIG. 2 is plan view illustrating a schematic configuration of a wafer processing system.

FIG. 3 is a plan view illustrating a schematic configuration of a laser radiating device.

FIG. 4 is a side view illustrating a schematic configuration of the laser radiating device.

FIG. 5A and FIG. 5B are side views illustrating an operation of a separating device.

FIG. 6 is an explanatory diagram illustrating a state of the combined wafer irradiated with laser light.

FIG. 7 is a flowchart illustrating main processes of a wafer processing in a wafer processing system.

FIG. 8 is an explanatory diagram illustrating diffusion of heat generated in the combined wafer.

FIG. 9 is an explanatory diagram illustrating a state of the combined wafer irradiated with laser light.

FIG. 10 is an explanatory diagram illustrating how a first wafer and a laser absorption layer are separated.

FIG. 11 is an explanatory diagram illustrating how the first wafer and the laser absorption layer are separated.

FIG. 12 is a flowchart illustrating main processes of a wafer processing in the wafer processing system.

FIG. 13 is an explanatory diagram illustrating individual regions of the combined wafer, a rotation speed of a chuck in the respective regions, and frequencies of laser light in the respective regions.

FIG. 14 is a side view illustrating an outer peripheral region and a first inner peripheral region.

FIG. 15 is an explanatory diagram illustrating a state of the combined wafer whose outer peripheral region is irradiated with laser light.

FIG. 16 is an explanatory diagram illustrating a state of the combined wafer whose outer peripheral region is irradiated with laser light.

FIG. 17 is an explanatory diagram illustrating a state of the combined wafer whose outer peripheral region is irradiated with laser light.

FIG. 18 is an explanatory diagram illustrating a state of the combined wafer whose first and second inner peripheral regions are irradiated with laser light.

FIG. 19 is an explanatory diagram illustrating a state of the combined wafer whose first inner peripheral region is irradiated with laser light.

FIG. 20 is an explanatory diagram illustrating a state of the combined wafer whose central region is irradiated with laser light.

FIG. 21A and FIG. 21B are explanatory diagrams illustrating a state of the combined wafer irradiated with laser light according to another exemplary embodiment.

FIG. 22A and FIG. 22B are explanatory diagrams illustrating a state of the combined wafer irradiated with laser light according to yet another exemplary embodiment.

FIG. 23 is an explanatory diagram illustrating a state of the combined wafer irradiated with laser light according to still yet another exemplary embodiment.

FIG. 24A to FIG. 24C are explanatory diagrams showing how a separation accelerating layer and a laser absorption layer are separated.

FIG. 25 is a flowchart illustrating main processes of a wafer processing according to another exemplary embodiment.

### DETAILED DESCRIPTION

In a manufacturing process for a semiconductor device, in a combined wafer in which two sheets of semiconductor substrates (hereinafter referred to as “wafers”) are bonded, a device layer formed on a front surface of a first wafer is transcribed to a second wafer. This transcription of the device layer to the second wafer is performed by radiating laser light to a laser absorption layer formed between the first wafer and the device layer to thereby separate the first wafer and the laser absorption layer. Specifically, while rotating the combined wafer and moving the laser light from an outer side to an inner side in a radial direction, the laser light is radiated to the laser absorption layer in pulses.

Here, a peripheral portion of the combined wafer has a chamfered portion (bevel portion), and this peripheral portion is not bonded. That is, an outer peripheral region of the combined wafer has a non-bonding region, and bonding strength at an interface between the first wafer (including the device layer) and the second wafer is weak at a boundary between the non-bonding region and a bonding region. In such a case, if laser light is radiated to the outer peripheral region, separation occurs at the interface between the first wafer and the second wafer, where the bonding strength is weak, in the outer peripheral region.

In this state, if the laser light is radiated while being moved from an outer side to an inner side in the radial direction in the outer peripheral region, separation is likely to occur in the bonding region adjacent to an inner side of the non-bonding region in the radial direction, with the separated interface between the first wafer and the second wafer as a leading end. That is, in the bonding region of the outer peripheral region, separation does not occur at the interface between the first wafer and the laser absorption layer as intended. As a result, the device layer of the first wafer W may not be transcribed to the second wafer.

The present disclosure provides a technique capable of appropriately carrying out separation between a first substrate and a laser absorption layer in a combined substrate in which the laser absorption layer is formed at an interface between the first substrate and a second substrate. Hereinafter, a wafer processing system equipped with a laser radiating device as a substrate processing apparatus, and a wafer processing method as a substrate processing method according to exemplary embodiments will be described with reference to the accompanying drawings. In the present specification and the drawings, parts having substantially the same functions and configurations will be assigned same reference numerals, and redundant descriptions thereof will be omitted.

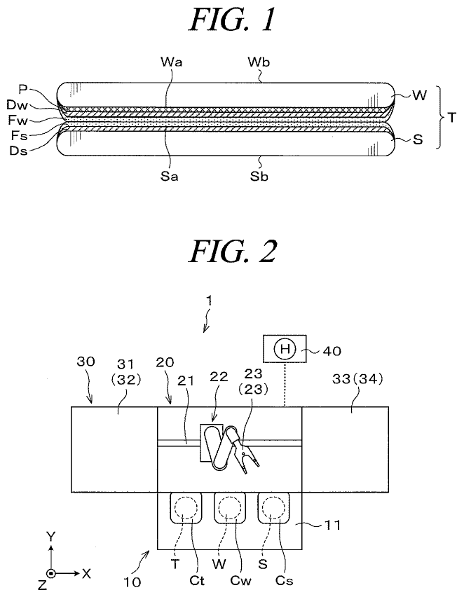

In a wafer processing system 1 according to an exemplary embodiment, which will be described later, a processing is performed on a combined wafer T as a combined substrate in which a first wafer W and a second wafer S are bonded to each other as illustrated in FIG. 1. Hereinafter, in the first wafer W, a surface bonded to the second wafer S is referred to as a front surface Wa, and a surface opposite to the front surface Wa is referred to as a rear surface Wb. Likewise, in the second wafer S, a surface bonded to the first wafer W is referred to as a front surface Sa, and a surface opposite to the front surface Sa is referred to as a rear surface Sb.

The first wafer W as a first substrate is, for example, a semiconductor wafer such as a silicon substrate. In the exemplary embodiment, the first wafer W has a substantially circular plate shape. A stacked film including a multiple number of films stacked on top of each other is formed on the front surface Wa of the first wafer W. The stacked film includes a laser absorption layer P, a device layer Dw and a front surface Fw in this order from the front surface Wa side. The device layer Dw includes a plurality of devices. The surface film Fw may be, by way of non-limiting example, an oxide film (a THOX film, a SiO₂ film, a TEOS film), a SIC film, a SiCN film, an adhesive, or the like. The first wafer W is bonded to the second wafer S with this surface film Fw therebetween. Further, the device layer Dw and the surface layer Fw may not be formed on the front surface Wa. In this case, the laser absorption layer P is formed on the second wafer S, and a device layer Ds of the second wafer S to be described later is transcribed to the first wafer W.

The laser absorption layer P absorbs laser light radiated from a laser radiator 110, as will be described later. For example, an oxide film (a SiO₂ film or a TEOS film) is used for the laser absorption layer P. However, the laser absorption layer P is not particularly limited as long as it absorbs the laser light. The laser absorption layer P is formed by a chemical vapor deposition (CVD) process outside the wafer processing system 1 to be described later, for example. The composition of the oxide film (the SiO₂ film or the TEOS film) as the laser absorption layer P may be varied depending on the type or a mixing ratio of processing gases for use in the CVD process.

The second wafer S as a second substrate is, for example, a semiconductor wafer such as a silicon substrate. A stacked film is formed on the front surface Sa of the second wafer S. The stacked film has a device layer Ds and a surface film Fs in this order from the front surface Sa side. The device layer Ds and the surface film Fs are the same as the device layer Dw and the surface film Fw of the first wafer W, respectively. The surface film Fw of the first wafer W and the surface film Fs of the second wafer S are bonded. Further, the device layer Ds and the surface film Fs may not be formed on the front surface Sa.

In the present disclosure, the stacked film formed at the interface between the first wafer W and the second wafer S, specifically, the laser absorption layer P, the device layers Dw and Ds, and the surface films Fw and Fs may be referred to as “interface layer”. In the present disclosure, the interface layer includes at least the laser absorption layer P.

Further, the type of the stacked film formed at the interface between the first wafer W and the second wafer S is not limited to the example shown in FIG. 1. By way of example, the stacked film may include a “separation accelerating film” to be described later for appropriately separating the first wafer W and the laser absorption layer P. In this case, the aforementioned interface layer includes the separation accelerating film.

As depicted in FIG. 2, the wafer processing system 1 has a configuration in which a carry-in/out block 10, a transfer block 20, and a processing block 30 are connected as one body. The carry-in/out block 10 and the processing block 30 are disposed around the transfer block 20. Specifically, the carry-in/out block 10 is disposed on the negative Y-axis side of the transfer block 20. A laser radiating device 31 and a separating device 32 of the processing block 30, both of which will be described later, are disposed on the negative X-axis side of the transfer block 20, and a first cleaning device 33 and a second cleaning device 34 to be described later are disposed on the positive X-axis side of the transfer block 20.

In the carry-in/out block 10, cassettes Ct, Cw, and Cs capable of accommodating a plurality of combined wafers T, a plurality of first wafers W and a plurality of second wafers S, respectively, are carried to/from the outside, for example. The carry-in/out block 10 is provided with a cassette placement table 11. In the shown example, a multiple number of, for example, the three cassettes Ct, Cw, and Cs can be arranged on the cassette placement table 11 in a row in the X-axis direction. Here, the number of the cassettes Ct, Cw, and Cs disposed on the cassette placement table 11 is not limited to the example of the present exemplary embodiment, but may be selected as required.

The transfer block 20 is provided with a wafer transfer device 22 configured to be movable on a transfer path 21 extending in the X-axis direction. The wafer transfer device 22 has, for example, two transfer arms 23 configured to hold and transfer the combined wafer T, the first wafer W, or the second wafer S. Each transfer arm 23 is configured to be movable in a horizontal direction, in a vertical direction, around a horizontal axis, and around a vertical axis. Here, however, it should be noted that the configuration of the transfer arm 23 is not limited to the present exemplary embodiment, and any of various configurations may be adopted. The wafer transfer device 22 is configured to be able to transfer the combined wafer T, the first wafer W, and the second wafer S to the cassettes Ct, Cw, and Cs of the cassette placement table 11, the laser radiating device 31, the separating device 32, the first cleaning device 33, and the second cleaning device 34.

The processing block 30 has the laser radiating device 31, the separating device 32, the first cleaning device 33, and the second cleaning device 34. As an example, the laser radiating device 31 and the separating device 32 are stacked on the negative X-axis side of the transfer block 20. Further, the first cleaning device 33 and the second cleaning device 34 are stacked on the positive X-axis side of the transfer block 20. However, the number and the layout of the laser radiating device 31, the separating device 32, the first cleaning device 33, and the second cleaning device 34 are not limited thereto.

The laser radiating device 31 radiates laser light to an inside of the combined wafer T, more specifically, to the laser absorption layer P formed on the front surface Wa of the first wafer W to thereby reduce bonding strength at the interface between the first wafer W and the laser absorption layer P.

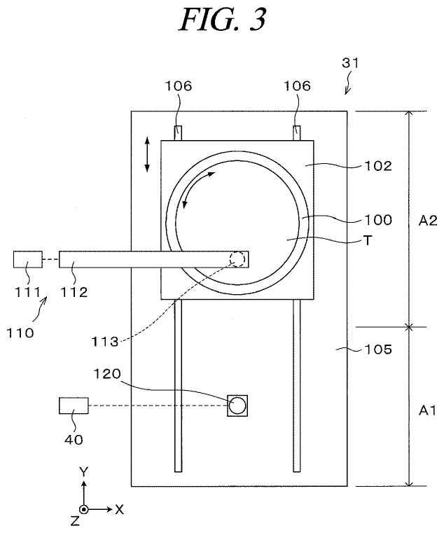

As shown in FIG. 3, a delivery position A1 and a processing position A2 are set inside the laser radiating device 31. The delivery position A1 is a position where the combined wafer T can be handed over from the transfer arm 23 onto a chuck 100 to be described later, and, also, is a position where the combined wafer T (laser absorption layer P) can be imaged by a camera 120 to be described later. The processing position A2 is a position where the laser light can be radiated to the combined wafer T (laser absorption layer P) from the laser radiator 110 to be described later.

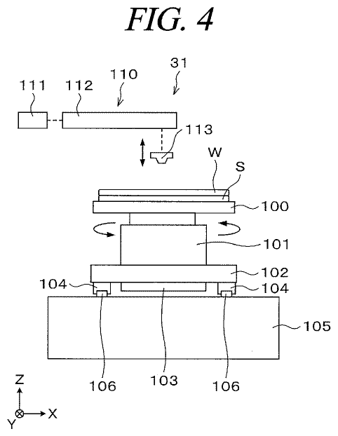

As depicted in FIG. 3 and FIG. 4, the laser radiating device 31 has the chuck 100 as a substrate holder, configured to hold the combined wafer T on a top surface thereof. The chuck 100 has a holding surface for the combined wafer T on its top surface, and attracts and holds the entire rear surface Sb of the second wafer S or a portion of an inner side of the rear surface Sb in the radial direction. The chuck 100 is, by way of non-limiting example, an electrostatic chuck (ESC) or a vacuum chuck. The chuck 100 is provided with an elevating pin (not shown) configured to support the combined wafer T from below and move it up and down. The elevating pin is configured to be movable up and down through a through hole (not shown) formed through the chuck 100.

The chuck 100 is supported on a slider table 102 with an air bearing 101 therebetween. A rotating mechanism 103 is provided on a bottom side of the slider table 102. The rotating mechanism 103 has, for example, a motor as a driving source embedded therein. The chuck 100 is configured to be rotatable around a θ axis (vertical axis) by the rotating mechanism 103 via the air bearing 101 therebetween. The slider table 102 is configured to be movable between the delivery position A1 and the processing position A2 by a moving mechanism 104, which is provided on the bottom side thereof, along a rail 106 that is provided on a base 105 and elongated in the Y-axis direction. Further, although not particularly limited, a driving source of the moving mechanism 104 may be, for example, a linear motor.

The laser radiator 110 is provided above the chuck 100 at the processing position A2. The laser radiator 110 has a laser head 111, an optical system 112, and a lens 113. The laser radiator 110 is capable of scanning the laser light. In the following description, scanning the laser light means moving the laser light radiated from the lens 113 of the laser radiator 110 with respect to the laser absorption layer P.

The laser head 111 has a laser oscillator (not shown) configured to oscillate the laser light in pulses. This laser light is a so-called pulse laser. In the present exemplary embodiment, the laser light is CO₂ laser light, and the wavelength of this CO₂ laser light is, for example, 8.9 μm to 11 μm. Also, the laser head 111 may have other devices, such as an amplifier, in addition to the laser oscillator.

The optical system 112 has an optical element (not shown) configured to control the intensity and the position of the laser light, an attenuator (not shown) configured to attenuate the laser light to adjust an output thereof, and a laser scanner (not shown) configured to scan the laser light. For the laser scanner, a rotary wedge scanner or a galvano scanner may be used, for example. The optical system 112 may also be configured to be able to control branching of the laser light.

The lens 113 radiates the laser light to the combined wafer T held by the chuck 100. The laser light emitted from the laser radiator 110 penetrates the first wafer W and is radiated to the laser absorption layer P. The lens 113 may be configured to be movable in a horizontal direction by a moving mechanism (not shown), or may be configured to be movable up and down in a vertical direction by an elevating mechanism (not shown).

In addition, the camera 120 is provided above the chuck 100 at the delivery position A1. The camera 120 has one or more cameras selected from a macro camera, a micro camera, and so forth. The camera 120 may be configured to be movable in a horizontal direction by a moving mechanism (not shown), or may be configured to be movable up and down in a vertical direction by an elevating mechanism (not shown).

The camera 120 is configured to image the combined wafer T held by the chuck 100. The camera 120 is equipped with, for example, a coaxial lens, and serves to radiate infrared light (IR) and receive reflected light from an object. Image data obtained by the camera 120 is outputted to a control device 40 to be described later.

As will be described later, the wafer processing system 1 has the control device 40, and this control device 40 is provided in the laser radiating device 31 and also functions as a controller for controlling the laser radiating device 31.

The separating device 32 as a separator is configured to separate the first wafer W from the second wafer S (combined wafer T), starting from the interface between the first wafer W and the laser absorption layer P, which serves as a separation portion whose bonding strength has been reduced by the laser radiating device 31.

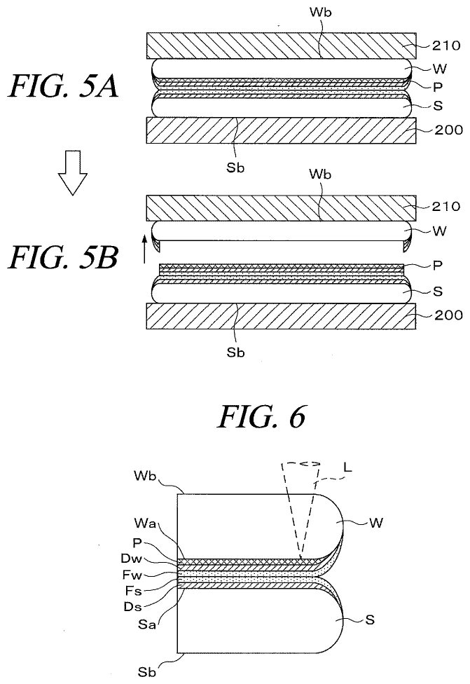

As an example, the separating device 32 has an attraction chuck 200 configured to attract and hold the rear surface Sb of the second wafer S from below, and an attraction pad 210 configured to attract and hold the rear surface Wb of the first wafer W from above, as illustrated in FIG. 5A and FIG. 5B. In the separating device 32, with the second wafer S attracted to and held by the attraction chuck 200 and the first wafer W attracted to and held by the attraction pad 210 as shown in FIG. 5A and FIG. 5B, the attraction pad 210 is raised to separate the first wafer W from the laser absorption layer P.

Further, the configuration of the separating device 32 is not limited to the above example, and any of various configurations may be used as long as the first wafer W can be separated from the second wafer S.

The first cleaning device 33 cleans the front surface Sa side of the second wafer S separated by the separating device 32. For example, a brush is brought into contact with the laser absorption layer P on the front surface Sa side of the second wafer S to clean the laser absorption layer P. Further, a pressurized cleaning liquid may be used to clean the second wafer S. The first cleaning device 33 may also be configured to clean the rear surface Sb of the second wafer S as well as the front surface Sa side thereof.

The second cleaning device 34 cleans the front surface Wa side of the first wafer W separated by the separating device 32. For example, a brush is brought into contact with the front surface Wa of the first wafer W to clean the front surface Wa. A pressurized cleaning liquid may be used to clean the first wafer W. The second cleaning device 34 may also be configured to clean the rear surface Wb of the first wafer W as well as the front surface Wa thereof.

Further, in the present exemplary embodiment, although the first cleaning device 33 for cleaning the second wafer S and the second cleaning device 34 for cleaning the first wafer W are provided independently as described above, the cleaning of the first wafer W and the cleaning of the second wafer S may be performed using one and the same cleaning device. In this case, the cleaning of the first wafer W and the second wafer S may be performed simultaneously or independently.

Moreover, in the present exemplary embodiment, although the first wafer W is separated from the second wafer S by using the separating device 32, such separation may be performed in the laser radiating device 31. By way of example, an elevatable transfer pad (not shown) is provided at the delivery position A1 of the laser radiating device 31. Then, with the second wafer S attracted to and held by the chuck 100, the transfer pad attracts and holds the first wafer W, and is then raised to separate the first wafer W from the second wafer S.

The above-described wafer processing system 1 is provided with the control device 40 as a controller. The control device 40 is, for example, a computer, and has a program storage (not shown). The program storage stores a program for controlling the processing of the combined wafer T in the wafer processing system 1. The program storage also stores a program for controlling an operation of a driving system such as the various processing apparatuses and the transfer devices described above to implement a wafer processing to be described later in the wafer processing system 1. Further, the programs may be recorded on a computer-readable recording medium H and may be installed from this recording medium H into the control device 40. The recording medium H may be either transitory or non-transitory.

Now, the wafer processing performed by using the wafer processing system 1 configured as above will be explained. In the present exemplary embodiment, the first wafer W and the second wafer S are bonded in a bonding apparatus (not shown) outside the wafer processing system 1 to form the combined wafer T in advance.

First, the cassette Ct accommodating the plurality of combined wafers T is placed on the cassette placement table 11 of the carry-in/out block 10.

Next, the combined wafer T in the cassette Ct is taken out by the wafer transfer device 22 and transferred to the laser radiating device 31. In the laser radiating device 31, the combined wafer T is handed over from the transfer arm 23 onto the chuck 100 disposed at the delivery position A1, and the rear surface Sb of the second wafer S is attracted to and held by the chuck 100. Subsequently, the chuck 100 is moved to the processing position A2 by the moving mechanism 104.

Thereafter, as depicted in FIG. 6, the laser radiator 110 focuses on the laser absorption layer P, more specifically, on the interface between the first wafer W and the laser absorption layer P, and radiates the laser light L (CO₂ laser light) to the interface. At this time, the laser light L penetrates the first wafer W from the rear surface Wb side of the first wafer W and is absorbed by the laser absorption layer P. This laser light L reduces the bonding strength between the first wafer W and the laser absorption layer P. In the exemplary embodiment, the term “reduced bonding strength” refers to a state in which the bonding strength is reduced as compared to before the radiation of laser light L at least, and includes the separation of the first wafer W and the laser absorption layer P.

The mechanism of the reduction in the bonding strength between the first wafer W and the laser absorption layer P caused by the radiation of the laser light L will be described later in detail.

In radiating the laser light L to the laser absorption layer P at the processing position A2, the combined wafer T (the first wafer W) is first imaged by the camera 120. The image data obtained by the camera 120 is outputted to the control device 40. The control device 40 determines a radiation start position of the laser light L for the laser absorption layer P based on this image data.

Thereafter, at the processing position A2, the laser light L is radiated at a required interval from the laser radiator 110 to the entire surface of the laser absorption layer P when viewed from the top, thereby reducing the bonding strength at the entire interface between the first wafer W and the laser absorption layer P. A method of radiating the laser light L to the laser absorption layer P will be described later in detail.

Once the bonding strength at the entire surface of the first wafer W and the laser absorption layer P is reduced as a result of radiating the laser light L to the entire surface of the laser absorption layer P, the chuck 100 (combined wafer T) is then moved to the delivery position A1 by the moving mechanism 104.

Next, the combined wafer T on the chuck 100 is delivered to the transfer arm 23 of the wafer transfer device 22 and transferred to the separating device 32. In the separating device 32, the rear surface Sb of the second wafer S is attracted to and held by the attraction chuck 200, and the rear surface Wb of the first wafer W is attracted to and held by the attraction pad 210, as shown in FIG. 5A. Then, with the first wafer W attracted to and held by the attraction pad 210, the attraction pad 210 is raised to separate the first wafer W from the laser absorption layer P, as illustrated in FIG. 5B. At this time, since the bonding strength at the interface between the first wafer W and the laser absorption layer P is reduced as a result of the radiation of the laser light L as stated above, the first wafer W can be separated from the laser absorption layer P without applying a large load.

The separated first wafer W is handed over from the attraction pad 210 onto the transfer arm 23 of the wafer transfer device 22 and is then transferred to the second cleaning device 34. At this time, the first wafer W taken out from the separating device 32 may be transferred to the second cleaning device 34 after its front and rear surfaces are inverted by operations of, for example, an inverting device (not shown) and the attraction pad 210 such that the front surface Wa faces upwards.

In the second cleaning device 34, the front surface Wa of the first wafer W, which is the surface separated by the separating device 32, is cleaned. In addition, in the second cleaning device 34, the rear surface Wb as well as the front surface Wa may be cleaned. Also, separate cleaners may be provided to wash the front surface Wa and the rear surface Wb, respectively. Thereafter, the first wafer W after being subjected to the cleaning by the second cleaning device 34 is transferred to the cassette Cw of the cassette placement table 11 by the wafer transfer device 22.

Meanwhile, the second wafer S held by the attraction chuck 200 is handed over to the transfer arm 23 and transferred to the first cleaning device 33. In the first cleaning device 33, the front surface Sa of the second wafer S, which is the surface separated by the separating device 32, specifically the front surface of the laser absorption layer P, is cleaned. Further, in the first cleaning device 33, the rear surface Sb of the second wafer S as well as the front surface of the laser absorption layer P may be cleaned. Also, separate cleaners may be provided to clean the front surface of the laser absorption layer P and the rear surface Sb of the second wafer S, respectively. Thereafter, the second wafer S after being subjected to the cleaning by the first cleaning device 33 is transferred to the cassette Cs of the cassette placement table 11 by the wafer transfer device 22.

In this way, the series of processes of the wafer processing in the wafer processing system 1 are completed.

Now, details of the mechanism of the reduction in the bonding strength between the first wafer W and the laser absorption layer P caused by the radiation of the laser light L at the processing position A2 of the above-described laser radiating device 31 will be described.

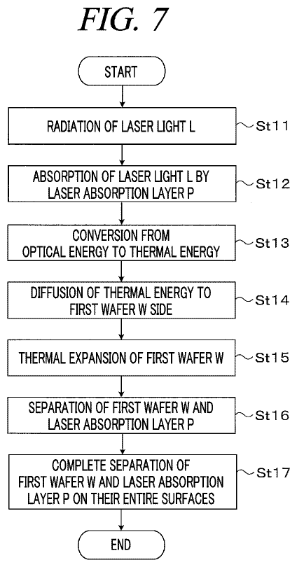

As described above, at the processing position A2 of the laser radiating device 31, the laser light L is radiated to the combined wafer T held by the chuck 100 from the rear surface Wb side of the first wafer W (process St11 in FIG. 7). The laser light L emitted from the lens 113 of the laser radiator 110 penetrates the silicon (first wafer W) to be absorbed by the laser absorption layer P, as shown in FIG. 6 (process St12 in FIG. 7).

The laser light L absorbed by the laser absorption layer P is converted into heat according to its energy distribution (process St13 in FIG. 7). In other words, due to the absorption of the laser light L, the temperature of the laser absorption layer P increases. The temperature of the laser absorption layer P is highest in a region directly under the radiation of the laser light L.

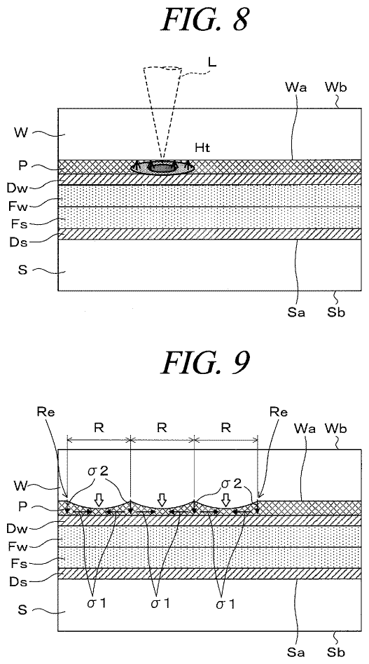

As shown in FIG. 8, most of the heat (denoted by Ht in the drawing) generated in the laser absorption layer P due to the absorption of the laser light L is diffused toward the first wafer W (process St14 in FIG. 7). In other words, due to the thermal diffusion from the laser absorption layer P, the temperature of the interface between the laser absorption layer P and the first wafer W (silicon) increases.

When the heat generated in the laser absorption layer P is diffused toward the first wafer W, due to the effect of this heat, that is, due to the increase in the temperature of the interface between the laser absorption layer P and the first wafer W, the portion of the first wafer W irradiated with the laser light L expands locally (plastically deforms downwards with respect to the laser absorption layer P) according to its temperature distribution, as shown in FIG. 9 (process St15 in FIG. 7).

Hereinafter, the region affected by the heat generated by the radiation of the laser light L may sometimes be referred to as “radiation region R” of the laser light L. In other words, the first wafer W expands locally in the radiation region R of the laser light L.

Once the first wafer W expands, the laser absorption layer P is pressurized from above (from the first wafer W side) due to the expansion of the first wafer W, and as a result, a compressive stress σ1 is generated in the laser absorption layer P at the position irradiated with the laser light L, as shown in FIG. 9. The generated compressive stress σ1 acts in a direction separating the first wafer W and the laser absorption layer P (in a downward direction in the drawing, toward the laser absorption layer P), as shown in FIG. 9, generating a separation stress σ2.

In other words, in the radiation region R of the laser light L, the silicon (first wafer W) expands in the region directly under the radiation of the laser light L (central portion of the radiation region R), generating the compressive stress σ1, and at an end Re (see FIG. 9) of the radiation region R, the separation stress σ2, which is a stress in the separation direction caused by the compressive stress σ1, is generated. This separation stress σ2 is a tensile stress generated at the end Re of the radiation region R.

The generated compressive stress σ1 and the separation stress σ2 are accumulated inside the laser absorption layer P. At this time, the separation stresses σ2 generated in multiple radiation regions R act in a multiplicative (overlapping) manner at the end Re of the radiation region R.

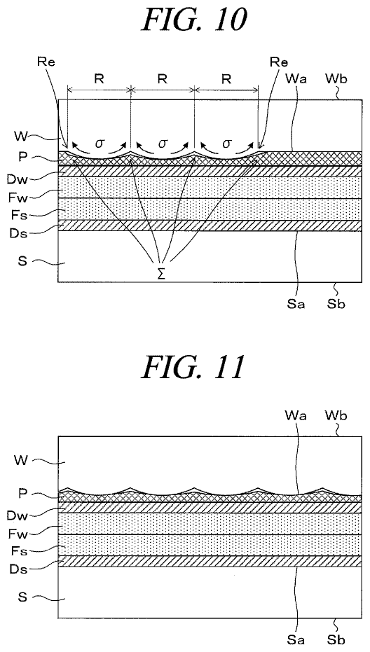

Then, when the accumulated total amount (multiplication amount) of the separation stress σ2 at the end Re of the radiation region R exceeds an adhesive strength Σ between the first wafer W and the laser absorption layer P per unit area at the end Re (n×σ2>Σ (n is a natural number indicating the repetition number of the radiation of the laser light L)), the separation occurs at the interface between the first wafer W and the laser absorption layer P at the end Re of the radiation region R, as shown in FIG. 10, and, as a result, the bonding strength between the laser absorption layer P and the first wafer W is reduced (process St16 in FIG. 7).

Further, the stress σ (the compressive stress σ1 and the separation stress σ2) accumulated inside the laser absorption layer P is released by the separation of the first wafer W and the laser absorption layer P.

Then, at the processing position A2 of the laser radiating device 31, by causing the separation to occur at the entire interface between the first wafer W and the laser absorption layer P when viewed from the top, as illustrated in FIG. 11, in other words, by extending the separation that has occurred at the end Re of the radiation region R over the entire interface between the first wafer W and the laser absorption layer P, the bonding strength between the first wafer Wand the laser absorption layer P is reduced in the entire surfaces thereof, so that the first wafer W and the laser absorption layer P can be appropriately separated in the separating device 32 (process St17 in FIG. 7).

In addition, in the combined wafer T after being subjected to the radiation of the laser light L at the processing position A2, it is ideal that the first wafer W is separated from the laser absorption layer P over the entire surface thereof, in other words, the first wafer W and the laser absorption layer P are separated from each other at the central portion of the radiation region R including the region directly under the radiation due to the separation stress σ2 after the separation has occurred at the end Re of the radiation region R. As illustrated in FIG. 10, however, the first wafer W and the laser absorption layer P may remain attached (not separated) at the central portion of the radiation region R (the region directly under the radiation of the laser light L) even after the separation has occurred at the end Re of the radiation region R. For this reason, in the wafer processing system 1 according to the technique of the present disclosure, in order to reliably separate the first wafer W from the combined wafer T (laser absorption layer P) in the combined wafer T after being subjected to the radiation of the laser light L, it is desirable to provide the separating device 32 and to provide a process of separating the first wafer W from the combined wafer T in the separating device 32.

Here, when the separation of the first wafer W from the combined wafer T is performed in the separating device 32, if the combined wafer T is transferred with respect to the separating device 32 in the aforementioned ideal state, that is, in the state in which the first wafer W is separated from the laser absorption layer P in the entire surface thereof, there is a risk that the first wafer W may fall off the second wafer S due to an inertial force or the like that accompanies this transfer.

Furthermore, if the first wafer W is separated from the laser absorption layer P in the entire surface thereof as stated above, even if there is no need to transfer the combined wafer T after being subjected to the radiation of the laser light L with respect to the separating device 32, there is a risk that the first wafer W may fly off the second wafer S due to the centrifugal force or the like that accompanies the rotation of the chuck 100 during the radiation of the laser light L to the laser absorption layer P at the processing position A2.

In view of the foregoing, in order to suppress the first wafer W from flying or falling off during the radiation of the laser light L to the laser absorption layer P and during the transfer of the combined wafer T, it is desirable to control radiation conditions (a radiation position, an output, etc.) of the laser light L so that at least a part of the interface between the first wafer W and the laser absorption layer P remains attached (not separated) at the processing position A2.

Accordingly, the first wafer W can be suppressed from being completely separated from the laser absorption layer P during the radiation of the laser light L or during the transfer to the separating device 32 to fly off or fall off the second wafer S.

The reduction in the bonding strength between the first wafer W and the laser absorption layer P at the processing position A2 of the laser radiating device 31 is performed as described above. That is, in the laser radiating device 31 according to the present exemplary embodiment, the first wafer W is expanded by the heat generated by the radiation of the laser light L, so that the compressive stress σ1 is generated in the laser absorption layer P. This compressive stress σ1 generates the separation stress σ2 at the interface between the first wafer W and the laser absorption layer P in the separation direction, which causes the separation to occur at the interface between the first wafer W and the laser absorption layer P. As a result, the bonding strength is reduced.

Further, in the above-described exemplary embodiment, the laser light L is radiated to the laser absorption layer P multiple times, as shown in FIG. 9, and when the accumulated total amount of the resultant separation stress σ2 exceeds the adhesive strength Σ between the first wafer W and the laser absorption layer P, the separation occurs at the end Re of the radiation region R. However, the repetition number of the radiation of the laser light L taken to achieve such separation is not limited to the multiple times.

By way of example, when the separation stress σ2 generated by single shot (one time) of radiation of the laser light L exceeds the adhesive strength Σ at the end Re, the single shot of radiation of the laser light L may cause the separation at the interface between the first wafer W and the laser absorption layer P at the end Re of the radiation region R.

Now, the method of radiating the laser light L to the laser absorption layer P at the processing position A2 of the above-described laser radiating device 31 will be described in detail.

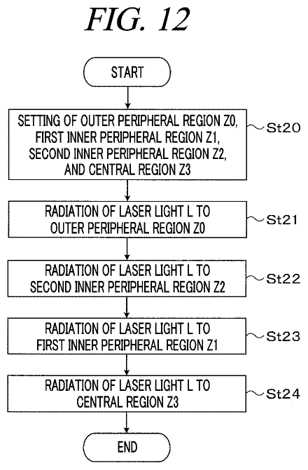

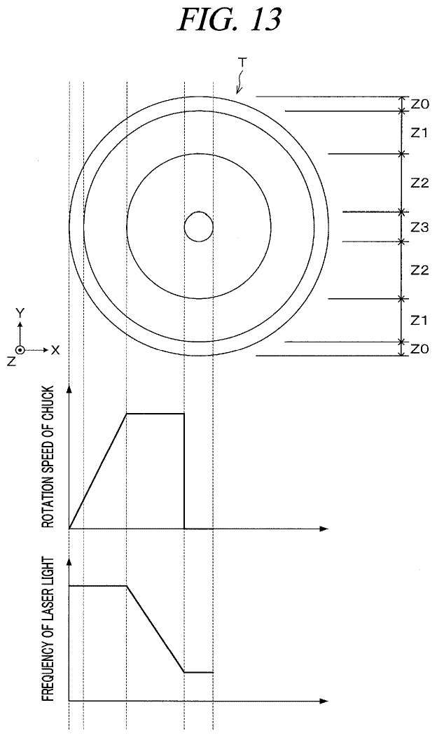

First, as shown in FIG. 13, regions of the combined wafer T (laser absorption layer P) when viewed from the top are set into an outer peripheral region Z0, a first inner peripheral region Z1, a second inner peripheral region Z2, and a central region Z3 (process St20 in FIG. 12). As a specific example, an operator sets the outer peripheral region Z0, the first inner peripheral region Z1, the second inner peripheral region Z2, and the central region Z3, and these outer peripheral region Z0, first inner peripheral region Z1, the second inner peripheral region Z2, and the central region Z3 are stored in the control device 40. The outer peripheral region Z0, the first inner peripheral region Z1, the second inner peripheral region Z2, and the central region Z3 are arranged in this order from an outer side toward an inner side in the radial direction. Also, the outer peripheral region Z0, the first inner peripheral region Z1, and the second inner peripheral region Z2 are arranged in an annular shape concentric with the combined wafer T, and the central region Z3 is disposed in a circular shape concentric with the combined wafer T.

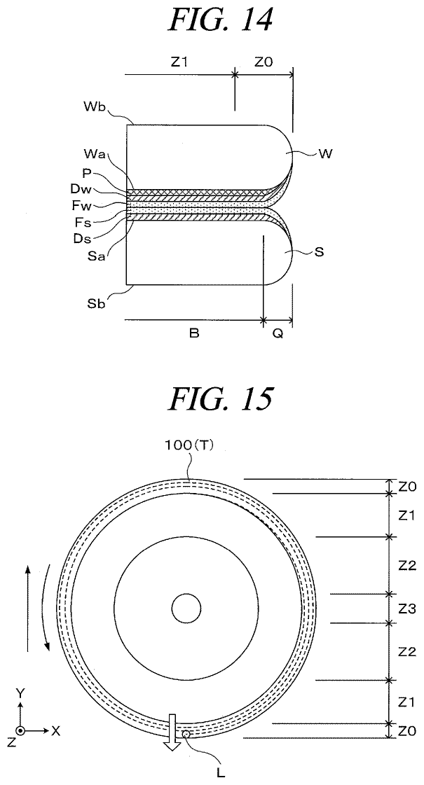

As shown in FIG. 13 and FIG. 14, the outer peripheral region Z0 is a peripheral region of the combined wafer T, and includes a non-bonding region Q where the first wafer W (surface film Fw) and the second wafer S (surface film Fs) are not bonded, and a bonding region B inside the non-bonding region Q in the radial direction. The non-bonding region Q includes a chamfered portion (bevel portion) with a chamfered periphery. Further, the non-bonding region Q also includes a region where the first wafer W and the second wafer S are not bonded due to, for example, misalignment of bonding positions or other factors.

The first inner peripheral region Z1, the second inner peripheral region Z2, and the central region Z3 are regions disposed in the bonding region B of the first wafer W and the second wafer S.

Here, in the present exemplary embodiment, the laser light L is radiated in pulses while rotating the combined wafer T and moving the laser light L in the radial direction. At this time, in order to perform the separation of the first wafer W and the laser absorption layer P uniformly in the surface of the wafer, it is desirable that an interval at which the laser light L is radiated, i.e., a pulse interval is set to be constant. In order to make the radiation interval of the laser light L constant, the rotation speed of the combined wafer T is increased as the laser light Lis moved from an outer side toward an inner side in the radial direction. Also, when the rotation speed of the combined wafer T reaches an upper limit, a frequency at the time of radiating the laser light L in pulses is reduced as the laser light L is moved from the outer side toward the inner side in the radial direction, for example. Then, when the rotation speed of the combined wafer T reaches the upper limit and the frequency of the laser light reaches a lower limit, the radiation interval of the laser light L is reduced as the laser light L is moved from the outer side toward the inner side in the radial direction, so the laser light L may overlap at the central region of the combined wafer T.

In view of the foregoing, in the present exemplary embodiment, the laser light Lis radiated to the outer peripheral region Z0, the first inner peripheral region Z1, and the second inner peripheral region Z2 while rotating the combined wafer T. In the central region Z3, on the other hand, the laser light L is scanned while the rotation of the combined wafer T is stopped.

In the outer peripheral region Z0 and the first inner peripheral region Z1, the laser light L is radiated in pulses, while maintaining the frequency of the laser light L constant and varying the rotation speed of the combined wafer T along with the movement of the laser light L in the radial direction. Specifically, when the laser light L is moved from the outer side toward the inner side in the radial direction, the rotation speed of the combined wafer T is increased, whereas when the laser light L is moved from the inner side toward the outer side in the radial direction, the rotation speed of the combined wafer T is reduced.

In the second inner peripheral region Z2, the laser light Lis radiated in pulses, while keeping the rotation speed of the combined wafer T constant and varying the frequency of the laser light L along with the movement of the laser light Lin the radial direction. Specifically, when the laser light L is moved from the outer side toward the inner side in the radial direction, the frequency of the laser light L is reduced, whereas when the laser light L is moved from the inner side toward the outer side in the radial direction, the frequency of the laser light L is increased.

Furthermore, a boundary position between the first inner peripheral region Z1 and the second inner peripheral region Z2 is set to a position where the rotation speed of the combined wafer T reaches the upper limit. A boundary position between the second inner peripheral region Z2 and the central region Z3 is set to a position where the frequency of the laser light L reaches the lower limit.

Next, the laser light L is radiated to the laser absorption layer P. At this time, processing conditions for the laser processing are changed for the individual regions Z0 to Z3. In this exemplary embodiment, radiation of the laser light L to the outer peripheral region Z0 (process St21 in FIG. 12), radiation of the laser light L to the second inner peripheral region Z2 (process St22 in FIG. 12), radiation of the laser light L to the first inner peripheral region Z1 (process St23 in FIG. 12), and radiation of the laser light L to the central region Z3 (process St24 in FIG. 12) are performed in this order.

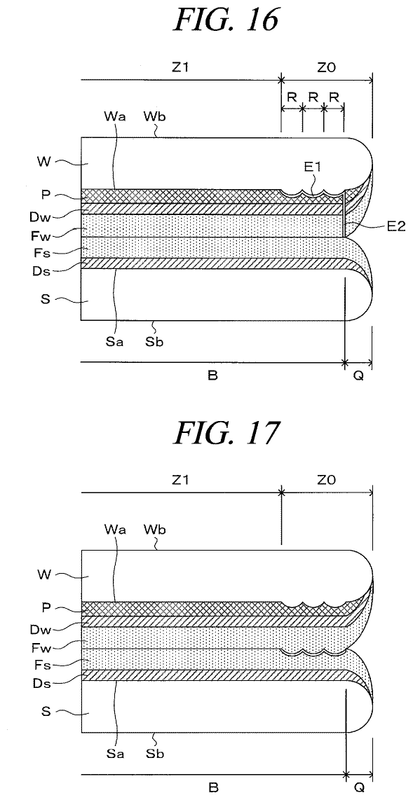

In the process St21, in the outer peripheral region Z0, the laser light L is radiated in pulses while rotating the chuck 100 (combined wafer T held by the chuck 100) counterclockwise by the rotating mechanism 103 and moving the chuck 100 in the positive Y-axis direction by the moving mechanism 104, as shown in FIG. 15. At this time, the laser light L is fixed without being scanned. As a result, in the outer peripheral region Z0, the laser light Lis radiated in a spiral shape from the inner side toward the outer side in the radial direction. Also, due to the separation mechanism of the first wafer W and the laser absorption layer P caused by the radiation of the laser light L described above, the separation occurs at the interface between the first wafer W and the laser absorption layer P in the outer peripheral region Z0, as shown in FIG. 16.

Further, since the outer peripheral region Z0 includes the non-bonding region Q, the bonding strength between the first wafer W and the second wafer S, i.e., the bonding strength between the surface film Fw and the surface film Fs is low at the boundary between the non-bonding region Q and the bonding region B. In this case, when the laser light L is radiated to the outer peripheral region Z0, the separation does not occur between the first wafer W and the laser absorption layer P in the outer peripheral region Z0 when the separation stress σ2 does not exceed the adhesive strength Σ between the first wafer W and the laser absorption layer P, as shown in FIG. 17. Then, a protruding shape of the interface between the first wafer W and the laser absorption layer P is transferred to the surface film Fw, and the stress acts on the interface between the surface film Fw and the surface film Fs. Due to this stress, the separation may occur at the interface between the surface film Fw and the surface film Fs, which has the low bonding strength, at the boundary between the non-bonding region Q and the bonding region B. In this state, if the laser light L is radiated in the outer peripheral region Z0 while moving the laser light L from the outer side toward the inner side in the radial direction, the separation may easily proceed in the bonding region B adjacent to an inner side of the non-bonding region Q in the radial direction, with the separated interface between the surface film Fw and the surface film Fs as a leading end. That is, in the bonding region B of the outer peripheral region Z0, the separation may not occur at the required interface between the first wafer W and the laser absorption layer P.

As a resolution, in the present exemplary embodiment, the laser light L is radiated from the inner side toward the outer side in the radial direction in the outer peripheral region Z0. As a result, as shown in FIG. 16, separation E1 occurs at the interface between the first wafer W and the laser absorption layer P in the bonding region B. At this time, the stress σ is generated in each radiation region R so that the separation E1 occurs from the center to the end Re. In order to generate such a large stress o, the frequency of the laser light L may be increased (the pitch of the laser light L may be shortened) or the radiation intensity of the laser light L may be increased, for example. In addition, at the boundary between the bonding region B and the non-bonding region Q, separation E2 proceeds from the interface between the first wafer W and the laser absorption layer P toward the interface between the surface film Fw and the surface film Fs as the bonding strength at the interface between the surface film Fw and the surface film Fs is low. Further, even if the separation E2 occurs, the device layer Dw outside the separation E2 in the radial direction is not affected thereby as it is a device that is not productized.

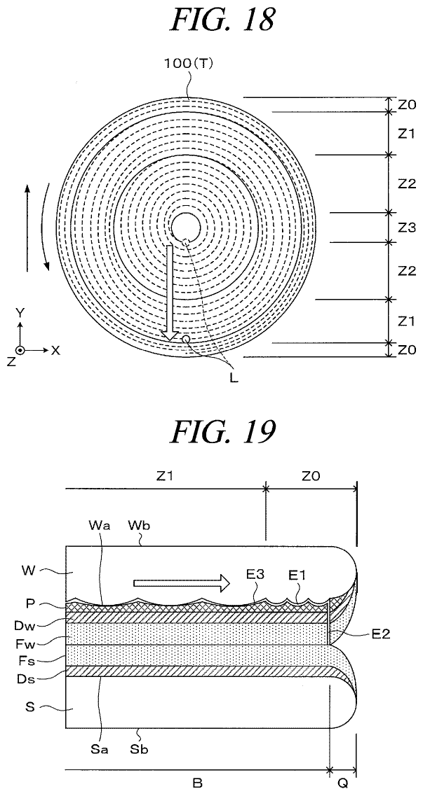

Next, in the process St22, in the second inner peripheral region Z2, the laser light L is radiated while rotating the chuck 100 counterclockwise by the rotating mechanism 103 and moving the chuck 100 in the positive Y-axis direction by the moving mechanism 104, as illustrated in FIG. 18. At this time, the laser light L is fixed without being scanned. As a result, in the second inner peripheral region Z2, the laser light L is radiated in a spiral shape from the inner side toward the outer side in the radial direction. Also, in the second inner peripheral region Z2, the separation occurs at the interface between the first wafer W and the laser absorption layer P, as shown in FIG. 11.

Then, in the process St23, the laser light L is also radiated to the first inner peripheral region Z1 in continuation with the radiation of the laser light L to the second inner peripheral region Z2 in the process St22, as shown in FIG. 18. That is, the laser light L is radiated in pulses while rotating the chuck 100 counterclockwise by the rotating mechanism 103 and moving the chuck 100 in the positive Y axis direction by the moving mechanism 104. At this time, the laser light L is fixed without being scanned.

As a result, in the process St23, the laser light L is radiated in a spiral shape from the inner side toward the outer side in the radial direction in the first inner peripheral region Z1. The spiral shape of the laser light L in this first inner peripheral region Z1 is continuous with the spiral shape of the laser light L in the second inner peripheral region Z2 and the spiral shape of the laser light L in the outer peripheral region Z0. That is, in the outer peripheral region Z0, the first inner peripheral region Z1, and the second inner peripheral region Z2, since the rotation direction of the chuck 100 is the same (counterclockwise direction) and the radiation direction (moving direction) of the laser light L is the same (from the inner side to the outer side in the radial direction), the spiral shape of the laser light L is continuous.

Also, in the process St23, the separation occurs at the interface between the first wafer W and the laser absorption layer P in the first inner peripheral region Z1, as illustrated in FIG. 19. The separation of the interface between the first wafer W and the laser absorption layer P in this first inner peripheral region Z1 is continuous with the separation of the interface between the first wafer W and the laser absorption layer P in the second inner peripheral region Z2 and the separation of the interface between the first wafer W and the laser absorption layer P in the outer peripheral region Z0.

Further, in the second inner peripheral region Z2 of the process St22 and the first inner peripheral region Z1 of the process St23, the first wafer W and the laser absorption layer P are separated or the bonding strength therebetween is weakened at the end Re in each radiation region R, and the first wafer W and the laser absorption layer P are connected at the central portion. That is, the stress σ accumulated inside the laser absorption layer P is small in the second inner peripheral region Z2 and the first inner peripheral region Z1, as compared to the outer peripheral region Z0. In order to generate such a small stress o, the frequency of the laser light L may be reduced (the pitch of the laser light L may be lengthened) or the radiation intensity of the laser light L may be reduced, for example. When the pitch of the laser light L is lengthened, the time required for the laser processing can be shortened, so that throughput can be improved. Further, when the radiation intensity of the laser light L is reduced, the laser processing can be carried out efficiently.

Here, if the stress σ large enough to completely separate the interface between the first wafer W and the laser absorption layer P is generated in the second inner peripheral region Z2 and the first inner peripheral region Z1, there is a risk that the first wafer W may be broken. Therefore, in the second inner peripheral region Z2 and the first inner peripheral region Z1, the first wafer W and the laser absorption layer P are separated with at least a portion of the interface therebetween remaining bonded as stated above, thus suppressing the first wafer W from being broken.

Then, as shown in FIG. 19, when separation E3 of the interface between the first wafer W and the laser absorption layer P in the first inner peripheral region Z1 is connected to the separation E1 in the outer peripheral region Z0, the entire interface between the first wafer W and the laser absorption layer P in the first inner peripheral region Z1 and the second inner peripheral region Z2 are separated. The aforementioned state in which “the bonding strength between the first wafer W and the laser absorption layer P is weakened at the end Re” refers to bonding strength causing the end Re to be separated when the separation E3 of the interface between the first wafer W and the laser absorption layer P in the first inner peripheral region Z1 is connected to the separation E1 in the outer peripheral region Z0 as stated above.

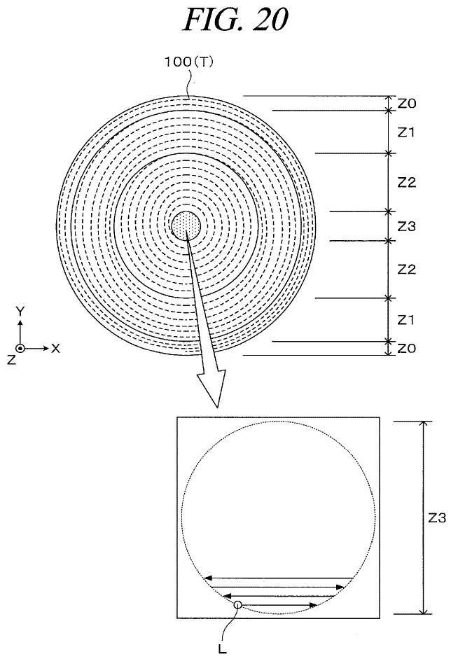

Next, in the process St24, the rotation of the chuck 100 is stopped in the central region Z3. Then, the laser light L is radiated from the laser radiator 110 in pulses. Also, the laser light L is scanned in the central region Z3. At this time, as shown in FIG. 20, the scanning radiation of the laser light L in the X-axis direction and the moving of the chuck 100 (combined wafer T) in the Y-axis direction are alternately repeated. Alternatively, the scanning radiation of the laser light L in the X-axis direction and the moving of the chuck 100 in the negative Y-axis direction may be synchronized. In addition, in order to improve the throughput of the wafer processing, the laser light L may be branched by the optical system 112 described above to be radiated simultaneously to multiple points of the laser absorption layer P. Further, due to the separation mechanism of the first wafer W and the laser absorption layer P caused by the radiation of the laser light L described above, separation occurs at the interface between the first wafer W and the laser absorption layer P in the central region Z3.

According to the present exemplary embodiment, by performing the processes St20 to St24, the separation can be incurred at the interface between the first wafer W and the laser absorption layer P. As a result, the first wafer W and the laser absorption layer P can be separated, and the device layer Dw of the first wafer W can be transcribed to the second wafer S.

In addition, in the outer peripheral region Z0 in the process St21, as the laser light L is radiated while moving it from the inner side to the outer side in the radial direction, the separation can be caused at the interface between the first wafer W and the laser absorption layer P. This results in the reduction in the bonding strength at the interface between the first wafer W and the laser absorption layer P, so that the first wafer W and the laser absorption layer P can be separated.

Furthermore, in the second inner peripheral region Z2 in the process St22 and the first inner peripheral region Z1 in the process St23, as the laser light Lis radiated continuously from the inner side toward the outer side in the radial direction, the separation can be made continuous appropriately at the interface between the first wafer W and the laser absorption layer P.

Moreover, if it is taken into account to appropriately transfer the combined wafer T after being irradiated with the laser light L in the laser radiating device 31 as described above, it is desirable that at least a portion of the interface between the first wafer W and the laser absorption layer P remains bonded. Therefore, it is desirable to maintain a state in which at least a portion of the interface between the first wafer W and the laser absorption layer P in at least one of the first inner peripheral region Z1, the second inner peripheral region Z2, and the central region Z3 remains bonded.

Further, in order to obtain the above-described effects of the present exemplary embodiment, that is, in order to separate the first wafer W and the laser absorption layer P at the interface therebetween in the outer peripheral region Z0 at least, the laser light L needs to be radiated from the inner side toward the outer side in the radial direction in the outer peripheral region Z0. The other processing conditions are not limited to the above-described exemplary embodiment.

Specifically, the processing conditions for the laser processing may be changed as required for the regions Z0 to Z3 individually. The processing conditions include, by way of non-limiting example, the rotation speed of the chuck 100, the frequency of the laser light L, the rotation direction of the chuck 100, the processing order (radiation order of the laser light L) of the regions Z0 to Z3.

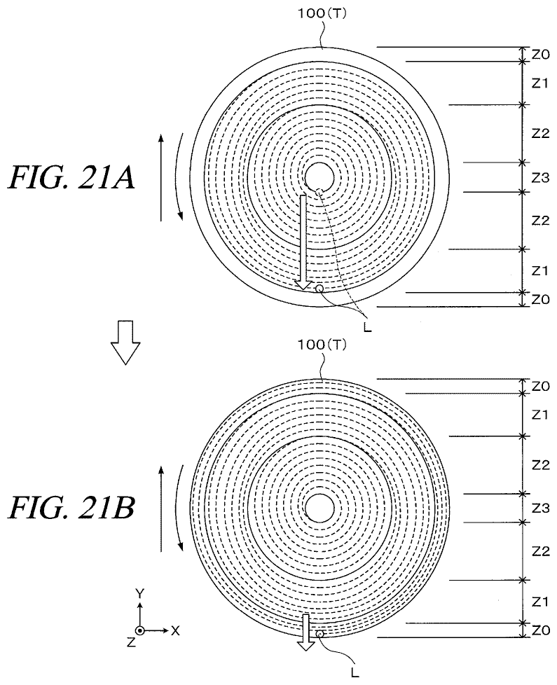

For example, as depicted in FIG. 21A and FIG. 21B, the radiation of the laser light L to the second inner peripheral region Z2, the radiation of the laser light L to the first inner peripheral region Z1, the radiation of the laser light L to the outer peripheral region Z0, and the radiation of the laser light L to the central region Z3 may be performed in this order.

In this case, as shown in FIG. 21A, the laser light Lis radiated in pulses in the second inner peripheral region Z2 and the first inner peripheral region Z1 while rotating the chuck 100 counterclockwise by the rotating mechanism 103 and moving the chuck 100 in the Y-axis direction by the moving mechanism 104 in the same manner as in the processes St22 and St23.

In each radiation region R in the second inner peripheral region Z2 and the first inner peripheral region Z1, the first wafer W and the laser absorption layer P are separated or the bonding strength therebetween is weakened at the end Re, and the first wafer W and the laser absorption layer P are connected at the central portion thereof. That is, in the second inner peripheral region Z2 and the first inner peripheral region Z1, the stress σ accumulated inside the laser absorption layer P is reduced. As described above, if the large stress σ is generated and accumulated, the first wafer W may be broken. In view of this, by setting the stress σ to be small as in the present exemplary embodiment, it is possible to suppress the breaking of the first wafer W. Further, the aforementioned state in which “the bonding strength between the first wafer W and the laser absorption layer P is weakened at the end Re” refers to the bonding strength that causes the end Re to be separated when the separation E3 of the interface between the first wafer W and the laser absorption layer P in the first inner peripheral region Z1 is connected to the separation E1 in the outer peripheral region Z0.

Next, as illustrated in FIG. 21B, in the outer peripheral region Z0, the laser light Lis radiated in pulses while rotating the chuck 100 counterclockwise by the rotating mechanism 103 and moving the laser light L in the positive Y axis direction by the moving mechanism 104 in the same manner as in the process St21. In the outer peripheral region Z0, the stress σ which is large enough to allow the separation E1 to occur from the central portion to the end Re is generated in each radiation region R.

Thereafter, in the central region Z3, the laser light Lis scanned in the state that the rotation of the chuck 100 is stopped, the same as in the process St24. As a result, in the central region Z3, the separation occurs at the interface between the first wafer W and the laser absorption layer P.

In the present exemplary embodiment, the same effect as in the above-described exemplary embodiment can be obtained. That is, the separation can be incurred at the interface between the first wafer W and the laser absorption layer P.

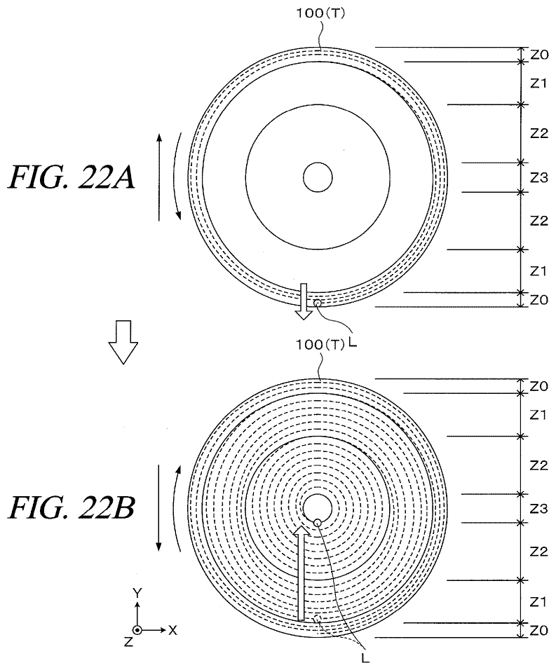

As another example, in the first inner peripheral region Z1 and the second inner peripheral region Z2, the laser light L may be radiated while moving it from the outer side to the inner side in the radial direction, as shown in FIG. 22A and FIG. 22B. In this case, the radiation of the laser light L to the outer peripheral region Z0, the radiation of the laser light L to the first inner peripheral region Z1, the radiation of the laser light L to the second inner peripheral region Z2, and the radiation of the laser light L to the central region Z3 may be performed in this order.

First, in the outer peripheral region Z0, the laser light L is radiated in pulses while rotating the chuck 100 counterclockwise by the rotating mechanism 103 and moving the chuck 100 in the positive Y-axis direction by the moving mechanism 104 in the same manner as in the process St21, as illustrated in FIG. 22A. As a result, in the outer peripheral region Z0, the laser light L is radiated in a spiral shape from the inner side toward the outer side in the radial direction. In the outer peripheral region Z0, the stress σ large enough to cause the separation E1 to occur from the central portion to the end Re is generated in each radiation region R.

Next, in the first inner peripheral region Z1, the laser light L is radiated in pulses while rotating the chuck 100 clockwise by the rotating mechanism 103 and moving the chuck 100 in the negative Y-axis direction by the moving mechanism 104, as illustrated in FIG. 22B. As a result, in the first inner peripheral region Z1, the laser light Lis radiated in a spiral shape from the outer side toward the inner side in the radial direction.

In this case, the rotation direction of the chuck 100 is opposite and the radiation direction of the laser light L is also opposite in the outer peripheral region Z0 and the first inner peripheral region Z1 which are adjacent to each other. As a result, the spiral shape of the laser light L can be made continuous in the outer peripheral region Z0 and the first inner peripheral region Z1. In other words, when the radiation direction of the laser light L is different in the adjacent regions, the spiral shape of the laser light L can be made continuous by reversing the rotation direction of the chuck 100 in the adjacent regions.

Next, in the second inner peripheral region Z2 as well, the laser light L is radiated in pulses while rotating the chuck 100 clockwise by the rotating mechanism 103 and moving the chuck 100 in the negative Y-axis direction by the moving mechanism 104. As a result, in the second inner peripheral region Z2, the laser light Lis radiated in a spiral shape from the outer side toward the inner side in the radial direction.

In addition, the magnitude of the stress σ accumulated inside the laser absorption layer P in the first inner peripheral region Z1 and the second inner peripheral region Z2 is not particularly limited. When the laser light L is radiated to the first inner peripheral region Z1, the separation of the interface between the first wafer W and the laser absorption layer P caused by this laser light L is connected to the separation E1 in the outer peripheral region Z0. Accordingly, in the first inner peripheral region Z1, the first wafer W and the laser absorption layer P are appropriately separated at the interface therebetween. Then, this separation reaches the second inner peripheral region Z2, so that the first wafer W and the laser absorption layer P are appropriately separated at the interface therebetween in the second inner peripheral region Z2 as well.

Thereafter, in the central region Z3, the laser light L is scanned while the rotation of the chuck 100 is stopped, the same as in the process St24. As a result, in the central region Z3, separation occurs at the interface between the first wafer W and the laser absorption layer P.

In the present exemplary embodiment, the same effect as in the above-described exemplary embodiment can be obtained. That is, separation can be incurred at the interface between the first wafer W and the laser absorption layer P.

In the above-described exemplary embodiments, the two inner peripheral regions (the first inner peripheral region Z1 and the second inner peripheral region Z2) are set in the process St20. However, the number of the inner peripheral regions may be one. In this inner peripheral region, the laser light L may be radiated in pulses while maintaining the frequency of the laser light L constant but varying the rotation speed of the combined wafer T along with the movement of the laser light L in the radial direction. Alternatively, in the inner peripheral region, the laser light L may be radiated in pulses while keeping the rotation speed of the combined wafer T constant but varying the frequency of the laser light L along with the movement of the laser light L in the radial direction. In either case, in the inner peripheral region, the processing conditions are controlled so that the radiation interval of the laser light L is constant.

In the above-described exemplary embodiments, the chuck 100 is moved horizontally when performing the laser processing. However, the lens 113 of the laser radiator 110 may be moved horizontally, or both the chuck 100 and the lens 113 may be moved horizontally. By moving the chuck 100 and the lens 113 horizontally relative to each other, the laser processing by the laser light L can be carried out.

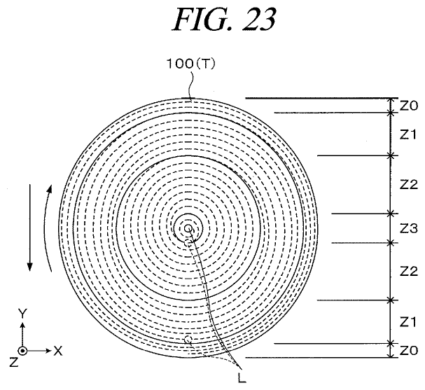

In the above-described exemplary embodiments, in the process St24, the laser light L is scan-radiated to the central region Z3 while the rotation of the chuck 100 is stopped. However, as shown in FIG. 23, the laser light L may be scan-radiated from the laser radiator 110 while rotating the chuck 100. In this case, the rotation speed of the chuck 100 in the central region Z3 may be set to be low, as compared to those of the outer peripheral region Z0, the first inner peripheral region Z1, and the second inner peripheral region Z2.

In the above-described exemplary embodiments, although the laser light L is radiated in the spiral shape in the outer peripheral region Z0, the first inner peripheral region Z1, and the second inner peripheral region Z2, the laser light may be radiated in a concentric ring shape. Also, in the exemplary embodiment shown in FIG. 23, although the laser light L is radiated in the spiral shape in the central region Z3 as well, the laser light L may be radiated in a concentric ring shape.

In the above-described exemplary embodiments, the separation occurs at the interface between the first wafer W and the laser absorption layer P, as shown in FIG. 8 to FIG. 11. As stated above, however, the separation accelerating film configured to appropriately separate the first wafer W and the laser absorption layer P may be formed on the front surface Wa of the first wafer W. In this case, the separation may be incurred at the interface between the separation accelerating film and the laser absorption layer P.

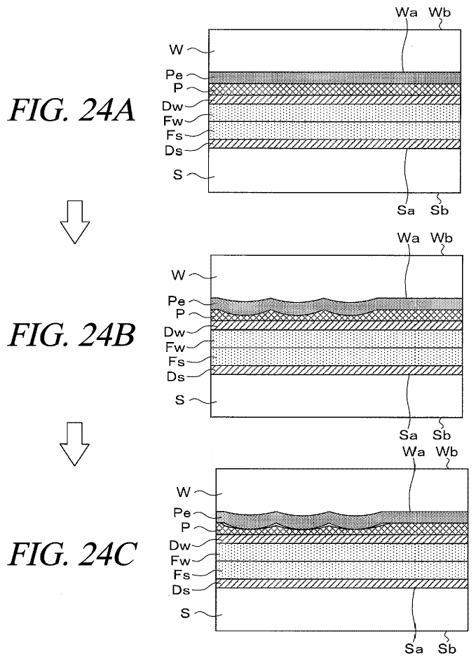

Specifically, as depicted in FIG. 24A, a separation accelerating film Pe, the laser absorption layer P, the device layer Dw, and the surface film Fw may be stacked on the front surface Wa of the first wafer W in this order. The separation accelerating film Pe is formed to accelerate the separation of the first wafer W from the second wafer S, and is made of a material, such as silicon nitride (SIN), whose adhesivity to the first wafer W (silicon) is lower than its adhesivity to the laser absorption layer P and which transmits the laser light L.

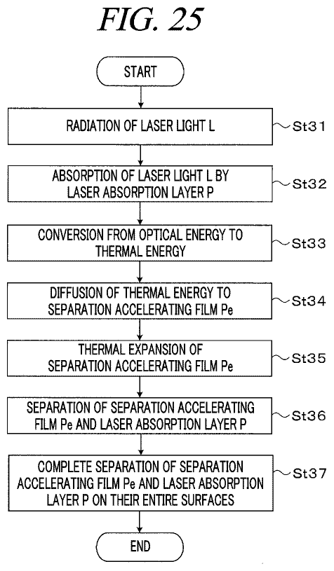

To separate the first wafer W from the second wafer S, the laser light L is first radiated to the laser absorption layer P (process St31 in FIG. 25). The laser light L penetrates the first wafer W and the separation accelerating film Pe and is absorbed by the laser absorption layer P (process St32 in FIG. 25).

The laser light L absorbed by the laser absorption layer P is converted into heat according to its energy distribution (process St33 in FIG. 25), so that the temperature of the laser absorption layer P increases. Most of the heat generated in the laser absorption layer P by the absorption of the laser light L is diffused to the separation accelerating film Pe on the first wafer W side (process St34 in FIG. 25), and due to this thermal diffusion, the temperature of the interface between the laser absorption layer P and the separation accelerating film Pe increases.

Once the heat generated in the laser absorption layer P is diffused to the first wafer W side, the separation accelerating film Pe is locally expanded according to its temperature distribution due to the effect of the heat, i.e., due to the increase in the temperature of the interface between the laser absorption layer P and the separation accelerating film Pe, as illustrated in FIG. 24B (process St35 in FIG. 25). At this time, the thermal effect of the interface between the laser absorption layer P and the separation accelerating film Pe may affect the first wafer W, so the first wafer W may also be locally expanded according to its temperature distribution, as shown in FIG. 24B.

Thereafter, if the separation accelerating film Pe (and the first wafer W) is locally expanded, a stress generated by this expansion causes separation at the interface between the laser absorption layer P and the separation accelerating film Pe having low adhesivity to each other, as shown in FIG. 24C, and, as a result, the bonding strength between the laser absorption layer P and the separation accelerating film Pe is reduced (process St36 in FIG. 25). Then, by extending the separation over the entire interface between the separation accelerating film Pe and the laser absorption layer P, the bonding strength between the separation accelerating film Pe and the laser absorption layer P is reduced over the entire surfaces thereof, so that the separation accelerating film Pe and the laser absorption layer P (the first wafer W and the second wafer S) can be properly separated in the separating device 32 (process St37 in FIG. 25).

In this way, by forming, on the front surface Wa of the first wafer W, the separation accelerating film Pe whose adhesivity to the first wafer W (silicon) is lower than its adhesivity to the laser absorption layer P and by expanding the separation accelerating film Pe instead of or together with the first wafer W, the device layer Dw formed on the front surface Wa of the first wafer W can be appropriately transcribed.

Further, in the example shown in FIG. 24A to FIG. 24C, the separation accelerating film Pe is formed at the interface between the first wafer W and the laser absorption layer P. As another example, however, the separation accelerating film Pe may be formed at the interface between the laser absorption layer P and the device layer Dw, and the separation may be incurred at the interface between the laser absorption layer P and the separation accelerating film Pe, thus allowing the separation accelerating film Pe to be left on the second wafer S side, to which the device layer Dw is to be transcribed.

The exemplary embodiments disclosed herein should be considered to be illustrative and not limiting in all aspects. The above-described exemplary embodiments may be omitted, replaced, or modified in various ways without departing from the spirit and scope of the appended claims. By way of example, the constituent components of the above-described exemplary embodiments may be combined in various ways. Such combinations naturally produce functions and effects of the respective constituent components of those combinations, and other functions and effects that are obvious to those skilled in the art may also be achieved from the description of the present specification.

Furthermore, the effects described in the present specification are merely explicative or illustrative, and are anyway limiting. In other words, the technique disclosed herein may produce, in addition to or in lieu of the aforementioned effects, effects that are apparent to those skilled in the art from the description of the present specification.

### EXPLANATION OF CODES

31: Laser radiating device
40: Control device
100: Chuck
103: Rotating mechanism
104: Moving mechanism
110: Laser radiator
L: Laser light
P: Laser absorption layer
S: Second wafer
T: Combined wafer
W: First wafer

1. A substrate processing apparatus configured to process a combined substrate in which a first substrate, an interface layer including at least a laser absorption layer, and a second substrate are stacked, the substrate processing apparatus comprising:
a substrate holder configured to hold the combined substrate;
a laser radiator configured to radiate laser light to the combined substrate held by the substrate holder;
a moving mechanism configured to horizontally move the substrate holder and the laser radiator relative to each other;
a rotating mechanism including a motor and configured to rotate the substrate holder; and
a controller having a processor and a memory with a computer readable program stored therein,
wherein an outer peripheral region including a non-bonding region of the first substrate and the second substrate, and an inner peripheral region disposed inside the outer peripheral region in a radial direction in a bonding region of the first substrate and the second substrate are set in the combined substrate, and
the controller executes:
a control of causing separation at an interface between the first substrate and the laser absorption layer or at an interface between the interface layer and the laser absorption layer by radiating the laser light to the combined substrate while rotating the combined substrate and moving the laser light in the radial direction; and
a control of radiating, at least in the outer peripheral region, the laser light while moving the laser light from an inner side toward an outer side in the radial direction.

2. The substrate processing apparatus of claim 1
wherein a first inner peripheral region on the outer side in the radial direction and a second inner peripheral region on the inner side in the radial direction are set in the inner peripheral region, and
the controller executes:
a control of radiating the laser light in pulses in the first inner peripheral region by varying a rotation speed of the combined substrate along with movement of the laser light while keeping a frequency of the laser light constant; and
a control of radiating the laser light in pulses in the second inner peripheral region by varying the frequency of the laser light along with the movement of the laser light while keeping the rotation speed of the combined substrate constant.

3. The substrate processing apparatus of claim 1,
wherein the controller executes a control of radiating the laser light in the inner peripheral region while moving the laser light from the inner side toward the outer side in the radial direction.

4. The substrate processing apparatus of claim 3,
wherein the controller executes a control of radiating the laser light such that a stress generated in the outer peripheral region by the laser light becomes greater than a stress generated in the inner peripheral region by the laser light.

5. The substrate processing apparatus of claim 1,
wherein the controller executes a control of radiating the laser light in the inner peripheral region while moving the laser light from the outer side toward the inner side in the radial direction.

6. The substrate processing apparatus of claim 1,
wherein the controller executes a control of reversing a rotation direction of the combined substrate in adjacent regions when a moving direction of the laser light is different between the adjacent regions.

7. The substrate processing apparatus of claim 1,
wherein the controller executes a control of radiating the laser light in the inner peripheral region after radiating the laser light in the outer peripheral region.

8. The substrate processing apparatus of claim 1,
wherein the controller executes a control of radiating the laser light in the outer peripheral region after radiating the laser light in the inner peripheral region.

9. The substrate processing apparatus of claim 1,
wherein a central region, which is disposed inside the inner peripheral region in the radial direction in the bonding region of the first substrate and the second substrate, is set in the combined substrate, and
the controller executes a control of radiating the laser light in the central region while scanning the laser light in a state where rotation of the combined substrate is stopped.

10. The substrate processing apparatus of claim 1,
wherein the interface layer includes a separation accelerating film, and
the separation at the interface between the interface layer and the laser absorption layer is incurred at an interface between the separation accelerating film and the laser absorption layer.

11. A substrate processing method configured to process a combined substrate in which a first substrate, an interface layer including at least a laser absorption layer, and a second substrate are stacked, the substrate processing method comprising:
setting, in the combined substrate, an outer peripheral region including a non-bonding region of the first substrate and the second substrate, and an inner peripheral region disposed inside the outer peripheral region in a radial direction in a bonding region of the first substrate and the second substrate;
holding the combined substrate with a substrate holder;
causing separation at an interface between the first substrate and the laser absorption layer or at an interface between the interface layer and the laser absorption layer by radiating laser light to the combined substrate from a laser radiator while rotating the combined substrate held by the substrate holder and moving the laser light in the radial direction; and
radiating, at least in the outer peripheral region, the laser light while moving the laser light from an inner side toward an outer side in the radial direction.

12. The substrate processing method of claim 11, further comprising:
setting, in the inner peripheral region, a first inner peripheral region on the outer side in the radial direction and a second inner peripheral region on the inner side in the radial direction;
radiating the laser light in pulses in the first inner peripheral region by varying a rotation speed of the combined substrate along with the moving of the laser light while keeping a frequency of the laser light constant; and
radiating the laser light in pulses in the second inner peripheral region by varying the frequency of the laser light along with the moving of the laser light while keeping the rotation speed of the combined substrate constant.

13. The substrate processing method of claim 11,
wherein in the inner peripheral region, the laser light is radiated while being moved from the inner side toward the outer side in the radial direction.

14. The substrate processing method of claim 13,
wherein the laser light is radiated such that a stress generated in the outer peripheral region by the laser light becomes greater than a stress generated in the inner peripheral region by the laser light.

15. The substrate processing method of claim 11,
wherein in the inner peripheral region, the laser light is radiated while being moved from the outer side toward the inner side in the radial direction.

16. The substrate processing method of claim 11,
wherein a rotation direction of the combined substrate is reversed in adjacent regions when a moving direction of the laser light is different between the adjacent regions.

17. The substrate processing method of claim 11,
wherein the laser light is radiated in the inner peripheral region after being radiated in the outer peripheral region.

18. The substrate processing method of claim 11,
wherein the laser light is radiated in the outer peripheral region after being radiated in the inner peripheral region.

19. The substrate processing method of claim 11, further comprising:
setting, in the combined substrate, a central region disposed inside the inner peripheral region in the radial direction in the bonding region of the first substrate and the second substrate; and
radiating the laser light in the central region while being scanned in a state where the rotating of the combined substrate is stopped.

20. The substrate processing method of claim 11,
wherein the interface layer includes a separation accelerating film, and the separation at the interface between the interface layer and the laser absorption layer is incurred at an interface between the separation accelerating film and the laser absorption layer.
